(19) United States
(12) Patent Application Publication
(10) Pub. No.: US 2009/0246388 A1
(43) Pub. Date: Oct. 1, 2009

(54) METHOD FOR PRODUCING POROUS FILM

(75) Inventors: Koju ITO, Minami-ashigara-shi (JP); Hidekazu YAMAZAKI, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/414,099

(22) Filed: Mar. 30, 2009

(30) Foreign Application Priority Data
Mar. 31, 2008 (JP) 2008-089676

(51) Int. Cl. B05D 5/00

(52) U.S. Cl. 427/373

(57) ABSTRACT

A second liquid is applied to a support and dried to form a middle layer. Then, a first liquid is applied to the middle layer. A third liquid is applied to a film of the first liquid using an inkjet type liquid supply unit to form a porous area. The first and third liquids differ in interfacial tension against water. Moist air is supplied to the porous area to cause condensation. In a third chamber, the condensation grows into large droplets, and a solvent is evaporated from the film. Thereafter, the droplets are evaporated from the porous area. Thus, a porous film in which a plurality of pores are arranged is produced. Since the porous area is formed by inkjet printing method, size, shape, and conditions of the porous area is easily changed.

### FIELD OF THE INVENTION

The present invention relates to a method for producing a porous film.

### BACKGROUND OF THE INVENTION

In the fields of optics and electronics, higher integration density, information of higher density, and image information with higher definition are required increasingly. For this reason, films with finer structures are strongly desired in such fields. In the medical field, the films with fine structures (microstructures) are also desired, for example, films that provide scaffolds for the cell culture, and membranes used for hemofiltration.

Examples of the microstructure films include films with honeycomb structures in which a plurality of micropores at a μm level are arranged in a honeycomb-like manner. To produce the honeycomb-structure film, a solution in which a predetermined polymer compound is dissolved in a hydrophobic organic compound is cast, and droplets are formed in a surface of a casting film by condensation. Such droplets are evaporated concurrently with evaporation of the organic compound (for example, see Japanese Patent Laid-Open Publication No. 2002-335949). The film produced in the above method is called a self-assembled membrane from formation behavior of its microstructure.

Uses of the honeycomb films are increasing by virtue of their microstructures. It is desired to form the honeycomb films with various patterns in accordance with the uses. However, it is difficult to form the honeycomb films with various patterns in which size and distribution of pores are changed due to processes for forming the honeycomb structure. To form a honeycomb film or a so-called self-assembled membrane, microdroplets are formed in the film of a casting liquid by condensation and then evaporated to form pores in the honeycomb-like arrangement. Methods for forming the honeycomb films with various patterns are desired.

### SUMMARY OF THE INVENTION

An object of the present invention is to provide a method for producing a porous film in which a plurality of pores are formed regularly with various patterns that differ in size and distribution of pores.

In order to achieve the above objects and other objects, a method for producing a porous film having a plurality of pores according to the present invention includes a first application step, and a second application step, a droplets forming step, and a pore forming step. In the first application step, a first liquid is applied to a support to form a film. The first liquid contains a polymer compound and a solvent. In the second application step, a second liquid is applied to the film using an inkjet head or a liquid metering and supplying device. The second liquid is different from the first liquid. In the droplets forming step, a plurality of droplets are formed on the applied second liquid by condensation. In the pore forming step, the solvent and the droplets are evaporated to form the plurality of pores in the film.

In the second application step, it is preferred that plural kinds of the second liquids are used, and each kind of the second liquid is applied separately to form an individual pattern. It is preferred that the applied second liquid forms pore forming areas for forming the plurality of pores. It is preferred that the second liquid and the film differ in interfacial tension against water.

In the second application step, it is preferred that plural kinds of the second liquids are used. The inkjet head or the liquid metering and supplying device has plural lines of ink orifices corresponding to the plural kinds of the second liquids, and the plural kinds of the second liquids are applied to form the pore forming areas with various patterns.

It is preferred that the second liquid has interfacial tension against water in a range from 5 mN/m to 20 mN/m. In the droplets forming step, it is preferred that humidification is performed to set an atmospheric dew point TD higher than a surface temperature TS of the film.

According to the present invention, the plurality of pores are formed regularly with various patterns that differ in size and distribution of pores.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an enlarged section view of a porous film of the present invention;

FIG. 2 is an enlarged plane view of the porous film;

FIG. 3A is an enlarged cross section of a porous film of another embodiment having shallow pores (hollows), and FIG. 3B is an enlarged cross section of a porous film of another embodiment having deep pores (hollows);

FIG. 4 is a schematic view of a porous film producing apparatus;

FIG. 5A is a schematic plane view showing an example of an inkjet type liquid supply unit of a line printing method, and FIG. 5B is a schematic plane view showing an example of a liquid metering and supplying device (dispenser);

FIG. 6 is a schematic plane view showing an example of an inkjet type liquid supply unit of a serial printing method;

FIG. 7A is an application pattern of porous areas to which droplets of a uniform diameter are supplied; FIG. 7B is an application pattern of two kinds of porous areas which differ in diameter of droplets supplied; and FIG. 7C is an application pattern of porous areas each supplied with droplets of four different diameters, and a third liquid that prevents condensation is applied to areas other than the porous areas;

FIGS. 8A and 8B are plane views showing examples of application patterns of porous areas each divided into plural divided areas that differ in diameter of the droplets supplied: FIG. 8A is an application pattern in which the porous are is divided in three divided areas by radioactive rays; and FIG. 8B is an application pattern in which the porous area is concentrically divided in three divided areas.

### DESCRIPTION OF THE PREFERRED EMBODIMENTS

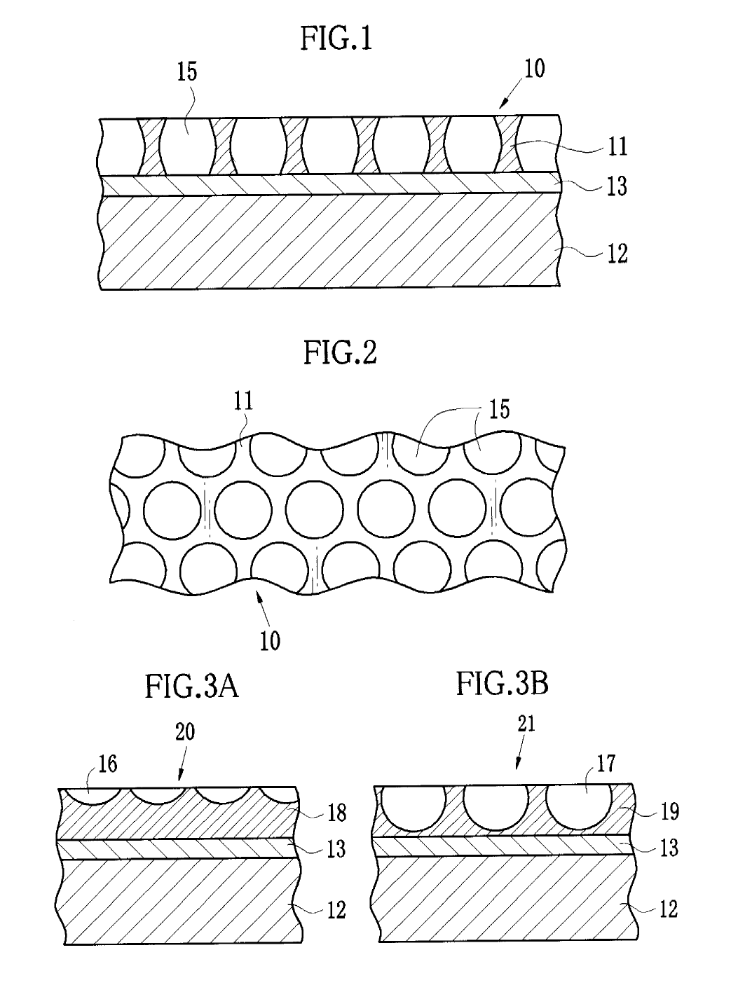

As shown in FIG. 1, a porous film 10 of the present invention includes a porous layer 11 formed with a plurality of pores 15, a support 12 for supporting the porous layer 11, and a middle layer 13 sandwiched between the porous layer 11 and the support 12. In this embodiment, the pores 15 are independent from each other. Alternatively, the pores may be connected to each other. As shown in FIG. 2, each pore 15 is substantially circular in shape. The porous film 10, as a whole, has a honeycomb structure with densely packed pores 15.

The pores 15 shown in FIG. 1 are through holes formed in the porous layer 11. Alternatively, shallow pores (hollows) 16 as shown in FIG. 3A or deep pores (hollows) 17 as shown in FIG. 3B may be formed. The pores 15, 16 and 17 are formed on porous layers 11, 18 and 19, respectively, by controlling a droplets growing process, which will be described later. For example, the shallow pores 16 are formed by stopping the growth of droplets at an early stage. The pores increase in depth as they grow, and thus the pores 15 and 17 are formed. In porous films 20 and 21 shown in FIGS. 3A and 3B, a component similar to that in FIG. 1 is designated by the same numeral shown in FIG. 1, and a description thereof is omitted.

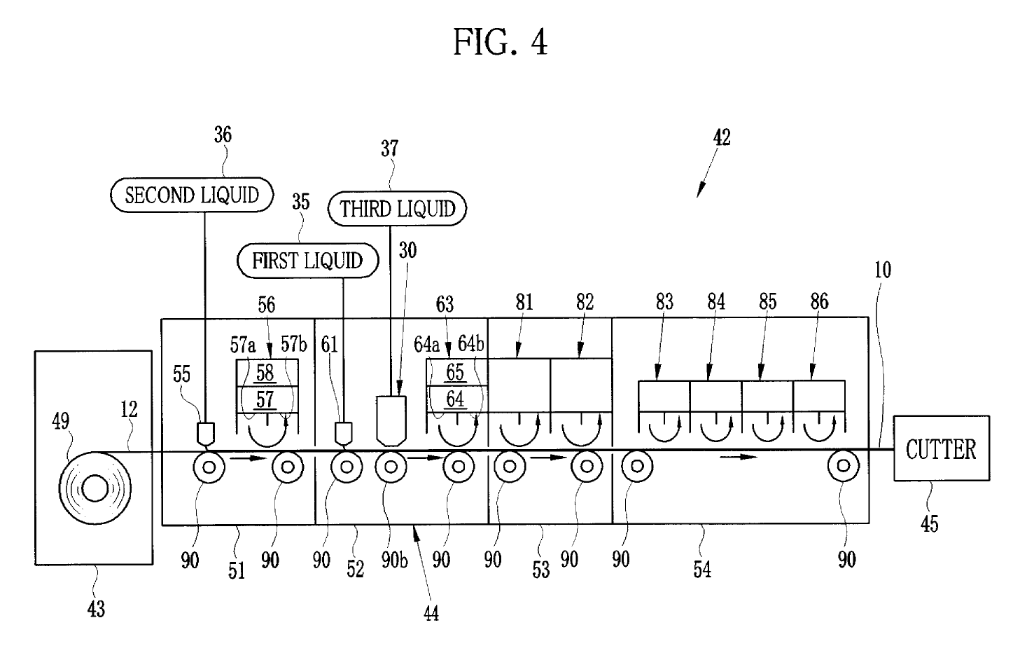

The porous layer 11 is formed from a first liquid 35 (see FIG. 4) containing a first polymer. The middle layer 13 is formed from a second liquid 36 (see FIG. 4) containing a second polymer. The support 12 and the middle layer 13 are not essential requirements in the present invention and provided as necessary. Instead of adopting a three-layer structure of the porous layer 11, the middle layer 13, and the support 12 as shown in FIGS. 1 to 3B, the support 12 and the middle layer 13 may be omitted, or the porous layer 11 may be peeled from the support 12 or the middle layer 13 in a film production process or when in use. In this case, the porous film 10 is formed with the porous layer 11 only, or has a two-layer structure of the porous layer 11 and the middle layer 13. The middle layer 13 may have a single or multiple layers as necessary.

The middle layer 13 is preferably provided to the porous layer 11 with the support 12. The middle layer 13 is also effective in supporting and protecting the porous layer 11 when the support 12 is peeled off and the porous film 10 has a two-layer structure of the porous layer 11 and the middle layer 13. The middle layer 13 is formed from the second polymer. The second polymer may be the same material as the first polymer. In this case, the thickness of the porous film 10 is increased, which provides self-supporting property. The second polymer may have a different composition from that of the first polymer. The second polymer may be soluble or insoluble in the first polymer.

The support 12 is necessary to the porous layer 11 in the film production process and in a product form except that the porous layer 11 has the self-supporting property. The support 12 may be used throughout the film production process and for the porous film 10 in the end-product form. Alternatively, a support specific for the film production process may be used. Such support may be referred to as film production support. In continuous film production, a stainless steel endless belt or a drum, or a polymer film may be used as the film production support. In film production using cut-sheet type supports, plate-like supports formed of stainless steel, glass, or polymer may be used. Such plate-like supports may be used during the film production process and for the end products.

The porous layer 11 is formed from a hydrophobic polymer compound and an amphipathic compound. Thereby, the droplets are formed more uniformly in shape and size in a porous film production method which will be described later. It is especially preferred that the middle layer 13 is a polymer compound. However, the middle layer 13 is not necessarily a polymer compound. The middle layer 13 may be, for example, an organic compound such as a monomer and an oligomer, or an inorganic compound such as TiO₂.

With the use of the film formed from the polymer compound as the support 12, the produced porous film 10 obtains flexibility. Compared to a porous material with a porous layer formed on glass, the porous film 10 is easy to handle and the porous film 10 has a high degree of flexibility in use. The high degree of flexibility means that the porous film 10 can be easily attached to a flat surface, bent, or cut into desired shapes. By virtue of the above, the porous film 10 can be used as a film for protecting wounds, a transdermal patch, and the like.

The first polymer and the amphipathic compound are used for forming the porous layer 11. A value of (the number of hydrophilic groups)/(the number of hydrophobic groups) in the amphipathic compound is preferred to be in a range from 0.1/9.9 to 4.5/5.5. Thereby, finer droplets are more densely packed in a film formed from the first liquid 35. In a case that the value (the number of hydrophilic groups)/(the number of hydrophobic groups) is smaller than the above range, the pores may vary in diameter and become nonuniform. The pores are judged nonuniform when a pore diameter variation coefficient (unit: %) obtained by the mathematical expression {(standard deviation of the pore diameter)/(an average pore diameter)}×100 is 10% or more. In a case that the value (the number of the hydrophilic group)/(the number of the hydrophobic group) is larger than the above range, an arrangement of the pores tends to be nonuniform.

The amphipathic compound may be formed of two or more different kinds of compounds. Thereby, the sizes and the positions of the droplets are more precisely controlled. The same effect can be obtained by using plural compounds as components of the polymer compound contained in the porous layer 11.

Preferable examples of the first polymer and the second polymer include vinyl polymer (for example, polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ethers, polyvinyl carbazole, polyvinyl acetate, polytetrafluoroethylene and the like), polyesters (for example, polyethylene terephthalate, polyethylene naphthalate, polyethylene succinate, polybutylene succinate, polylactate and the like), polylactones (for example, polycaprolactone and the like), cellulose acetate, polyamides and polyimides (for example, nylon, polyamic acid and the like), polyurethane, polyurea, polybutadiene, polycarbonate, polyaromatics, polysulfone, polyethersulfone, polysiloxane derivatives and the like.

Instead of the second polymer, gelatin, polyvinyl alcohol (PVA), sodium polyacrylate or the like may be used for forming the middle layer 13. In this case, the porous film 10 is nontoxic when used as the wound protection film or the transdermal patch. In addition, the middle layer 13 does not compromise the flexibility of the support 12. Therefore, it is easy to handle the porous film 10 and change its shape.

Examples of the polymer used as the support 12 are the same as those mentioned above as the preferable examples of the first polymer. In addition, to make the support 12 thick while imparting flexibility to the porous film 10, for example, cellulose acetate, cyclic polyolefin, polyester, polycarbonate, polyurethane, and polybutadiene are preferred. Thereby, the thick support 12 is produced at low cost, and the porous film 10 is resistant to tearing and its shape is easily changeable in use.

Solvents for the first liquid 35, the second liquid 36, and a third liquid 37 (see FIG. 4) are not particularly limited as long as the solvent is hydrophobic and dissolves the polymer compound. Examples of the solvent include aromatic hydrocarbon (such as benzene and toluene), halogenated hydrocarbon (such as dichloromethane, chlorobenzene, carbon tetrachloride, and 1-bromopropane), cyclohexane, ketone (such as acetone and methyl ethyl ketone), ester (such as methyl acetate, ethyl acetate, and propyl acetate) and ether (such as tetrahydrofuran, and methyl cellosolve). A mixture of the above compounds may be used as the solvent. Alcohol may be added to the above compound or the mixture of the above compounds.

In a case the solvent containing no dichloromethane is used to minimize the influence on the environment, the solvent preferably contains ether with 4 to 12 carbon atoms, ketone with 3 to 12 carbon atoms, ester with 3 to 12 carbon atoms, brominated hydrocarbons such as 1-bromopropane, or a mixture of them. For example, a solvent mixture of methyl acetate, acetone, ethanol, and n-butanol may be used. The ether, ketone, ester, and alcohol may have a cyclic structure. A compound having two or more functional groups of the ether, ketone, ester, and alcohol (that is, —O—, —CO—, —COO—, and —OH—) can be used as the solvent.

A droplet forming speed, a depth of the droplets in the film, and the like are controlled by using two or more kinds of compounds as the solvent and changing the ratio of the compounds as necessary. The droplet forming speed and the depth of the droplets will be described later.

The first liquid 35 preferably contains the first polymer in a range from 0.02 pts. wt. to 30 pts. wt. relative to 100 pts. wt. of an organic solvent. Thereby, the porous layer 11 of high-quality is formed with high productivity. In a case that the first polymer is less than 0.02 pts. wt. relative to 100 pts. wt. of the organic solvent, longer time is necessary for evaporating the organic solvent due to its large proportion in the first liquid 35. As a result, the productivity of the porous film 10 decreases. On the other hand, in a case that the first polymer exceeds 30 pts. wt., the droplets formed by condensation cannot change the shape of the film of the first liquid 35. As a result, a surface of the porous layer 11 may become uneven.

The third liquid 37 that forms a porous area (layer) 31 has interfacial tension against water in a range from 5 mN/m to 20 mN/m. To change the interfacial tension of the third liquid 37, a concentration of a surfactant or a kind of a surfactant may be changed. Other than those, a hydrophilic additive may be added to the third liquid 37. A hydrophilic solvent is preferably used as the hydrophilic additive. It is preferred that solubility of water in this hydrophilic solvent is at least 5 vol. %.

Examples of the hydrophilic solvent includes alcohol such as methanol, ethanol, n-propanol, isopropanol and tert-butanol, ketones such as acetone and methyl acetone, ethers such as tetrahydrofuran and dioxane, esters such as methyl formate, and glycol derivatives such as ethylene glycol, ethylene glycol monomethyl ether and ethylene glycol monoethyl ether.

It is preferred that the interfacial tension of the third liquid 37 against water is lower than that of the first liquid 35. To be more specific, the interfacial tension of the third liquid 37 against water is in a range from 5 mN/m to 20 mN/m, and more preferably in a range from 10 mN/m to 18 mN/m.

As shown in FIG. 4, a porous film producing apparatus 42 of the present invention includes a support feeder 43, an application chamber 44, and a cutter 45. The support feeder 43 pulls out the support 12 from a support roll 49 and sends the support 12 to the application chamber 44. In the application chamber 44, the first liquid 35, the second liquid 36, and the third liquid 37 are applied to the support 12 and dried to produce the porous film 10. The cutter 45 cuts the produced porous film 10 to a predetermined size. The cut porous film 10 is referred to as product film. The product film is subject to various processing. Thus, an end product film is produced.

The support feeder 43 and the cutter 45 are used for continuous mass production of the porous film 10, and may be omitted depending on a production scale. In a small scale production, cut-sheets may be used instead of the support roll 34. The cut sheets are the support 12 cut into sheet form.

The application chamber 44 is partitioned into a first chamber 51, a second chamber 52, a third chamber 53, and a fourth chamber 54. In the first chamber 51 are provided a first die 55 and a dryer 56. The second liquid 36 is applied to the support 12 from the first die 55. The dryer 56 is provided with a duct 57 having an outlet 57a and an intake 57b, and an air feeder 58. The air feeder 58 controls temperature, humidity, and velocity of dry air fed from the outlet 57a, and draws gas (air and vapors) surrounding the film from the intake 57b and circulates it. The supply of dry air and the suction of the gas by the air feeder 58 dry the film. Thus, the middle layer 13 is formed.

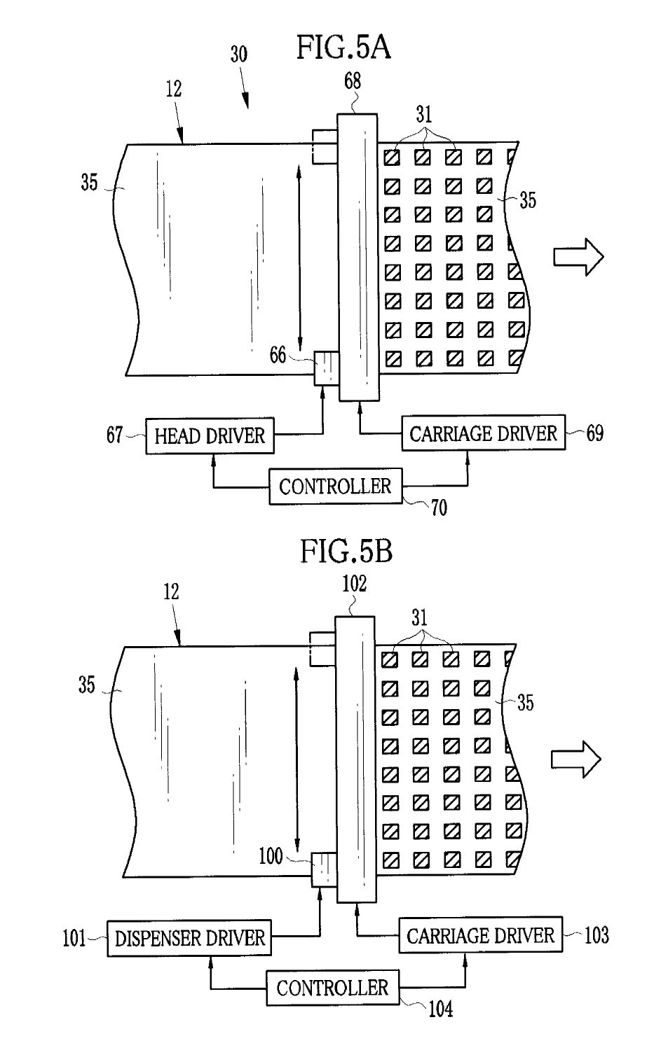

The second chamber 52 is provided with a second die 61, an inkjet type liquid supply unit 30, and a supply and suction unit 63. The first liquid 35 is applied to the middle layer 13 from the second die 61. The inkjet type liquid supply unit 30 is a liquid supplying unit of an inkjet type, and applies the third liquid 37 as fine droplets on the film of the first liquid 35 so as to form the porous areas (pore forming areas) 31 as shown in FIG. 5A. This formation of the porous areas 31 on the film of the first liquid 35 is referred to as inkjet application.

As shown in FIG. 4, the supply and suction unit 63 is provided with a duct 64 having an outlet 64a and an intake 64b, and an air feeder 65. The air feeder 65 controls temperature, dew point, and humidity of humidified (moist) air fed from the outlet 64a, and draws and exhausts gas surrounding the film from the intake 64b. The supply of air and suction of the gas by the air feeder 65 cause condensation on the porous area 31 of the third liquid 37. This condensation forms microdroplets on the film of the first liquid 35. The air feeder 65 is provided with a filter (not shown) for removing dust from moist air. Plural ducts 64 may be disposed in a moving direction of the support 12.

As shown in FIG. 5A, the inkjet type liquid supply unit 30 includes an inkjet head 66 of a serial print type, a head driver 67, a carriage 68, a carriage driver 69, and a controller 70. The inkjet type liquid supply unit 30 has a structure of a common inkjet printer except that the third liquid 37 is used instead of ink. The third liquid 37 has interfacial tension against water different from that of the first liquid 35. With the use of the inkjet type liquid supply unit 30, the porous areas (pore forming areas) 31 of the third liquid 37 are formed in an island structure with a predetermined pattern on the film of the first liquid 35. One or more kind of the third liquids 37 that differ in interfacial tension against water may be used. In this case, different kinds of the porous area 31 may be formed or each porous area 31 may be divided into divided areas in accordance with the kind of the third liquid 37.

The printing method may be either a line printing method or a serial printing method. In this embodiment, a serial printing method is adopted. The inkjet head 66 of the serial printing method is smaller than that of the line printing method.

In the serial printing method shown in FIG. 5A, the inkjet head 66 of the serial printing type is moved along the carriage 68 in the width direction of the support 12 by the carriage driver 69. Thereby, a printing area (swath) of one line of the ink orifices is printed by one pass of the inkjet head 66 across the carriage 68. The support 12 is conveyed intermittently after each pass. During the printing of the printing area, the support 12 is held still.

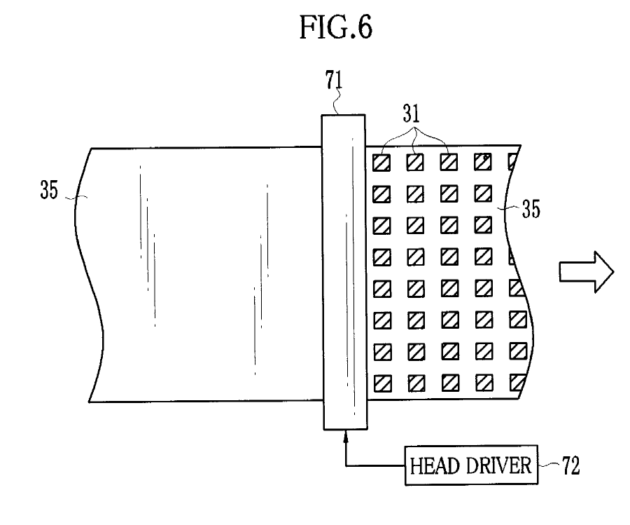

In the line printing method as shown in FIG. 6, a head driver 72 and the inkjet head 71 with a plurality of ink orifices aligned in an array in the width direction of the support 12 are used. The third liquid 37 is ejected from the ink orifices of the inkjet head 71, in synchronization with the conveyance of the support 12. Thus, the porous area 31 is formed on the film of the first liquid 35. In the line printing method, since the third liquid 37 is concurrently applied across the width direction of the support 12 using the inkjet head 71, the support 12 is conveyed continuously.

In FIG. 5B, instead of using inkjet heads 66 and 71, a liquid metering and supplying unit (dispenser) 100 may be used. Instead of the head driver 67 (see FIG. 5A), a dispenser driver 101 is used. The dispenser 100 is attached to a carriage 102. The dispenser 100 is moved by the carriage driver 103 to a desired position in the width direction of the support 12, and ejects a predetermined amount of the third liquid 37 to form the porous areas 31. The dispenser driver 101 and the carriage driver 103 are controlled by a controller 104. As with the ink orifices of the inkjet head 71 of the line printing method shown in FIG. 6, a plurality of the dispensers 100 may be disposed in the width direction of the support to form the porous areas 31. In this case, one or more kinds of the third liquid 37 are ejected from the plurality of dispensers 100 to the film of the first liquid 35. Each porous area 31 may be formed using one dispenser 100. Alternatively, one porous area 31 may be formed using the plurality of dispensers 100. In addition, a plurality of dispensers 100 may be arranged in a matrix in a plane direction to form a plurality of the porous areas 31 by one pass across the carriage 68.

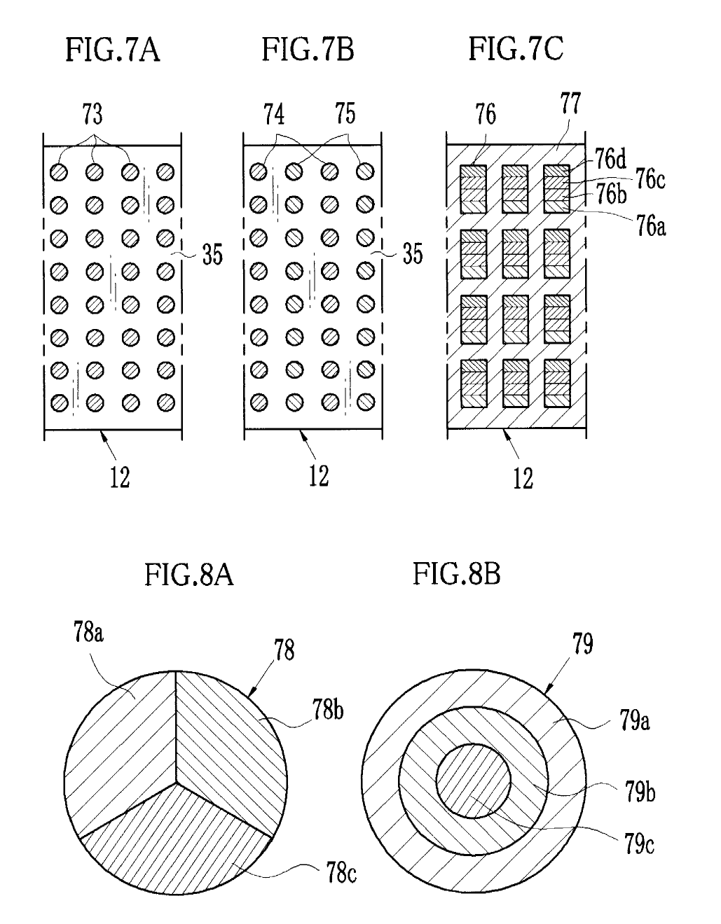

FIGS. 7A, 7B, and 7C are examples of patterning of the porous area. In FIG. 7A, circular porous areas 73 are arranged in a matrix by applying the third liquid 37 on the film of the first liquid 35. In FIG. 7B, two kinds of porous areas 74 and 75 are formed in separate rows by using two kinds of third liquid 37 that differ in interfacial force against water. Accordingly, the porous areas 74 and 75 differ from each other in size and growing speeds of the droplets. As a result, two kinds of the porous areas 74 and 75 that differ in diameter of the pores are formed. In FIG. 7C, rectangular porous areas 76 are arranged in a matrix using the third liquid 37. Additionally, the third liquid 37 that is different from the third liquid 37 of the porous area 76 is applied to an area on the film of the first liquid 35 except for the porous areas 76. The area to which the third liquid 37 of the different kind is applied is referred to coated area 77. The coated area 77 has resistance to condensation or does not cause condensation. A coated area may be formed in the cases shown in FIGS. 7A and 7B using a liquid for forming the coated area. The third liquid 37 with interfacial tension against water of 30 mN/m or above has resistance to condensation or does not cause condensation.

In addition to circular and rectangular shapes shown in FIGS. 7A to 7C, the porous areas 73 to 76 may take polygonal, ellipsoidal, doughnut-like, heart-like, or other shapes. The arrangement of the porous areas (pore forming areas) 73 to 76 is not limited to the matrix. The porous areas 73 to 76 may be arranged in a random manner.

As shown in FIGS. 8A and 8B, plural kinds of the third liquids 37 may be used separately in porous areas (pore forming areas) 78 and 79 to form different divided areas in each of the porous areas 78 and 79. For example, in FIG. 8A, the circular porous area 78 is divided into three sectors (divided areas) 78a to 78c using radioactive rays. The third liquid 37 applied to each divided area differs in interfacial tension against water. The divided areas differ from each other in diameter of the droplets depending on the kind of the third liquid 37. Alternatively, as shown in FIG. 8B, divided areas 79a to 79c may be formed concentrically in the circular porous area 79. The diameter of the droplets may be increased or decreased from the circumference to the center of the porous area 79. A different kind of the third liquid 37 is applied to each divided area. The porous area may be divided in other ways.

As shown in FIG. 7C, the rectangular porous area 76 may be divided into four divided areas 76a to 76d. The divided areas 76a to 76d differ from each other in diameter of the droplets supplied. The diameter may be gradually increased or decreased from the divided area 76a to the divided area 76d in this order.

As shown in FIG. 4, first and second supply and suction units 81 and 82 are provided in the third chamber 53. In the third chamber 53, microdroplets formed in the porous area 73 by condensation in a condensation process grow gradually. In the third chamber 53, at least one of during and after the droplets growing process, the solvent is evaporated. The first and the second suction units 81 and 82 are configured in the same manner as the supply and suction unit 63 and descriptions thereof are omitted.

It is preferred to set an air velocity from the first and the second supply and suction units 81 and 82 in accordance with the moving speed of the support. The air velocity is preferably in a range from 0.02 m/s to 2 m/s, more preferably from 0.05 m/s to 1.5 m/s, and most preferably from 0.1 m/s to 0.5 m/s. In a case that the relative speed is less than 0.02 m/s, the film is introduced to the fourth chamber 54 before the formation of droplets in the microstructure. On the other hand, in a case that the relative speed exceeds 2 m/s, the exposed surface of the film may become uneven or condensation may not proceed adequately.

In the fourth chamber 54 are provided third to sixth supply and suction units 83 to 86. In the fourth chamber 54, the droplets and the solvents are evaporated. The third to sixth supply and suction units 83 and 86 are configured similar to the supply and suction unit, and the descriptions thereof are omitted. The middle layer 13 and the porous layer 11 are formed on the support 12 as the support 12 moves through the first to the fourth chambers 51 to 54. The third liquid 37 is applied to the film of the first liquid 35 to form the porous areas 73, and then droplets are formed in the porous areas 73 by condensation. The droplets grow and become self-assembled. The plurality of pores 15 are formed by evaporation of the droplets. Thus, the porous layer 11 with the pores in a predetermined structure is formed.

The arrangement of the pores in the porous area 31 differs depending on a density and a size of the droplets, a drying speed, a solid concentration of the liquid for forming the porous layer, timing of evaporating the solvent in the liquid, and the like. The diameter and the density of the pores can be adjusted to desired values by changing the above conditions.

In each of the first to the fourth chamber 51 to 54 are provided a plurality of rollers 90 with appropriate pitches. The representative rollers 90 are shown in FIG. 4. Illustration of the other rollers 90 is omitted. Each roller 90 has a drive roller and a free roller. Throughout the first to the fourth chambers 51 to 54, the support 12 is conveyed at a constant speed with the use of the drive rollers disposed with the appropriate pitches. A temperature of the rollers 90 in each chamber is controlled by a temperature controller (not shown) so that the processes, such as the film drying process, the condensation process, the droplets growing process, and the pore forming process are performed in optimum conditions. A temperature plate (not shown) is disposed on the opposite side of the film surface, close to the support 12 between the rollers 90. The temperature control plate controls the temperature of the support 12 at a predetermined temperature.

In each of the first to the fourth chambers 51 to 54 of the application chamber 44, a solvent recovery device (not shown) is provided. The solvent recovery device recovers the solvent. The recovered solvent is refined in a refining device (not shown) and reused.

Next, an operation of this embodiment is described. As shown in FIG. 4, in the first chamber 51, the second liquid 36 is applied from the first die 55 onto the support 12 to form the film of the second liquid 36. The film of the second liquid 36 is dried by the dryer 56. Thus, the middle layer 13 is formed.

In the second chamber 52, the first liquid 35 is applied from the second die 61 onto the middle layer 13 to form the film of the first liquid 35. The first liquid 35 is applied such that the thickness of the film of the first liquid 35 before being dried is in a range from 0.01 mm to 1 mm. Even though the thickness is within the above range, the droplets may become random if the thickness varies. In a case that the thickness is less than 0.01 mm, the film of the first liquid 35 cannot be formed uniformly, and the first liquid 35 may be repelled on the middle layer 13 and cannot cover the middle layer 13. On the other hand, in a case that the thickness is more than 1 mm, drying time becomes too long, which lowers production efficiency.

As shown in FIG. 5A, the porous areas 31 are formed using the third liquid 37 ejected on the film of the first liquid 35 from the inkjet type liquid supply unit 30. This is referred to as patterning. The third liquid 37 and the first liquid 35 differ in interfacial tension against water. Since the third liquid 37 is more likely to cause condensation than the first liquid 35, condensation occurs on the porous areas 31. An extent of the condensation can be controlled by changing interfacial tension of the third liquid 37 against water. Other than the condensation conditions in the porous areas 31, the droplets growing process after the condensation process can be controlled by patterning of the third liquids that differ in concentration and components. The porous areas with different pore diameters can be formed by changing the kind of the third liquid 37 in each porous area.

In the condensation process in the second chamber 52, moist air is supplied to the film from the outlet 64a of the supply and suction unit 63. The gas surrounding the film is drawn and exhausted from the intake 64b. Here, a value ΔT is obtained by subtracting a film surface temperature TS of the film from a dew point TD of air supplied from the outlet 64a (ΔT=TD−TS). At least one of the film surface temperature TS and the dew point TD are controlled such that ΔT at least 3° C. and at most 30° C. (3° C.≦ΔT≦30° C.). The film surface temperature TS is measured by providing, for example, a non-contact thermometer such as a commercially available infrared thermometer close to the conveying path of the film. In a case that ΔT is lower than 3° C., the film resists formation of droplets. In a case ΔT is higher than 30° C., droplets are formed abruptly. As a result, the droplets may become nonuniform in size, or formed not in two-dimensional alignment, but in three dimensions.

In the second chamber 52, it is preferable to gradually decrease the value of ΔT in the support moving direction. This controls the droplets forming speed and the size of the droplets. As a result, the droplets uniform in diameter in the plane direction of the film (in two dimensions) are formed.

In the second chamber 52, the film surface temperature TS is adjusted by adjustment of the temperature of the rollers 90. Instead or in addition, a temperature control plate (not shown) may be used for controlling the film surface temperature TS. The temperature control plate is disposed on the opposite side of the film, close to the support 12 between the rollers. The dew point TD is controlled by changing conditions of moist air supplied from the supply and suction unit 63.

In the third chamber 53, with the use of the first and the second supply and suction units 81 and 82, the droplets formed by condensation in the second chamber 52 grow to a large size uniformly. As a distance between the second chamber 52 and the third chamber 53 increases, namely, as time between the formation of the droplets and entrance of the film in the third chamber 53 is extended, the size of the droplets become nonuniform after the growth. The number of the supply and suction unit is not limited to two. At least one supply and suction unit is used. Each of the first and the second supply and suction units 81 and 82 are configured similar to the supply and suction unit 63. However, the configuration is not limited to the above.

In the third chamber 53, the film surface temperature TS or the dew point TD is controlled such that ΔT (=TD−TS) is more than 0° C. and less than 10° C. (0° C.<ΔT<10° C.). The film surface temperature TS is controlled by a temperature control plate (not shown) provided close to the film. The film surface temperature TS has substantially the same structure as that used in the second chamber 52. The temperature control plate changes the temperature of the support 12.

To change the dew point TD, conditions of moist air supplied from the first and the second supply and suction units 81 and 82 are controlled. In the third chamber 53, the film surface temperature TS is measured by providing a temperature measuring device similar to the above close to the film. By setting the conditions of the third chamber 53 as described above, the droplets grow slowly and gradually, and arrangement of droplets 39 is promoted by capillary force. Thus, the uniform droplets 39 are densely formed.

In a case that ΔT is less than 0° C., the size, shape, and arrangement of the pores in the porous film may become nonuniform in addition to inadequate growth of the droplets that makes the formation of dense pore structure impossible. In a case that ΔT is higher than 10° C., the droplets may be formed in multi-layer structure (in three dimensions). As a result, the size, the shape and the arrangement of the pores may become nonuniform in the porous film 10. In the third chamber 53, it is preferred that the film surface temperature TS and the dew point TD are substantially equal.

It is preferred to evaporate as much solvent as possible while the droplets 39 grow. By setting the film surface temperature TS and the dew point TD within the above range in the third chamber 53, the solvent in the film is sufficiently evaporated, while abrupt evaporation is prevented. It is preferred to selectively evaporate the solvent without evaporating the droplets. For this reason, it is preferred that the solvent has higher evaporation speed than that of the droplets at the same temperature and pressure. Thereby, the droplets reach inside the film more easily when the solvent is evaporated.

In the fourth chamber 54, one of the film surface temperature TS or the dew point TD is controlled with the use of the four supply and suction units 83 to 86 so as to set the film surface temperature TS higher than the dew point TD. The film surface temperature TS is mainly controlled by the temperature control plate. The dew point TD is controlled by controlling conditions of the dry air supplied from the outlet. The film surface temperature TS is measured by providing a temperature measuring device similar to the above close to the film. By setting the film surface temperature TS higher than the dew point TD, the growth of the droplets is stopped and the droplets are evaporated. Thus, the porous film with the uniform pores is produced. If the dew point TD is set equal to or higher than the film surface temperature TS (TS≦TD), further condensation occurs on the droplets and may damage the porous structure, which is unfavorable.

A main objective of providing the fourth chamber 54 is to evaporate droplets therein. However, the remaining solvent in the film is also evaporated in the fourth chamber 54.

In the droplets evaporation process in the fourth chamber 54, a decompression drying device or a so-called 2D nozzle may be used instead of the third to the sixth supply and suction unit 83 to 86. Decompression drying makes it easy to adjust evaporation speeds of the organic solvent and the droplets individually. Thereby, the droplets are formed inside the film and evaporated together with the organic solvent in better conditions. The pores controlled to be uniform in size, shape, and conditions are formed at the positions of the droplets. The 2D nozzle has supply nozzles for supplying air and suction nozzles for sucking air close to the film. The supply nozzles and the suction nozzles are arranged alternately in the support conveying direction.

Each of the first and the second liquids 35 and 36 is applied and spread onto a support placed still, or applied using an inkjet type liquid supply unit, or applied to a moving support from a die. Any of the above methods can be used in the present invention. In general, the spreading method and the application method using the inkjet type liquid supply unit are suitable in producing many kinds of porous films in small quantities, namely, a so-called production of many models in small quantities. In general, the applying method using the die is suitable for the mass production. In any case, a long porous film is produced by applying or casting the liquid continuously, and a porous film of a predetermined length is produced by applying or casting the liquid intermittently.

In a case a cut-sheet shaped support is used instead of the belt-like continuous support 12 shown in FIGS. 4 to 6, the porous film is produced by conveying the support from the first chamber to the fourth chamber in this order in the same manner as the continuous support. Alternatively, for the cut-sheet shaped support, one application chamber may be used. In this application chamber, applications of the second liquid for forming the middle layer, the first liquid for forming the porous layer, and the third liquid for forming the porous area, the condensation process, the droplets growing process, and the drying process may be performed.

Various changes and modifications are possible in the present invention and may be understood to be within the present invention.

What is claimed is:

1. A method for producing a porous film having a plurality of pores comprising the steps of:
applying a first liquid on a support to form a film, said first liquid containing a polymer compound and a solvent;
applying a second liquid on said film using an inkjet head or a liquid metering and supplying device, said second liquid being different from said first liquid;
forming a plurality of droplets on said applied second liquid by condensation; and
evaporating said solvent and said droplets to form said plurality of pores in said film.

2. The method of claim 1, wherein plural kinds of said second liquids are used in said applying step of said second liquid, and each kind of said second liquid is applied separately to form an individual pattern.

3. The method of claim 1, wherein said applied second liquid forms pore forming areas for forming said plurality of pores.

4. The method of claim 3, wherein said second liquid and said film differ in interfacial tension against water.

5. The method of claim 4, wherein in said applying step of said second liquid, plural kinds of said second liquids are used, and said inkjet head or said liquid metering and supplying device has plural lines of ink orifices corresponding to said plural kinds of said second liquids, and said plural kinds of said second liquids are applied to form said pore forming areas with various patterns.

6. The method of claim 4, wherein said second liquid has interfacial tension against water in a range from 5 mN/m to 20 mN/m.

7. The method of claim 1, wherein in said forming step, humidification is performed to set an atmospheric dew point TD higher than a surface temperature TS of said film.
